(19) United States
(12) Patent Application Publication
(10) Pub. No.: US 2019/0084133 A1
(43) Pub. Date: Mar. 21, 2019

(54) RATCHET INCLUDING A SLIDABLE AND ROTATABLE RATCHET ARM

(71) Applicant: Campbell Hausfeld, LLC, Harrison, OH (US)

(72) Inventors: Nicholas Steven Hafele, Cincinnati, OH (US); Reid Charles Butler, Edgewood, KY (US); Rodney A. Ratz, Brookville, IN (US)

(21) Appl. No.: 16/136,085

(22) Filed: Sep. 19, 2018

Related U.S. Application Data
(60) Provisional application No. 62/560,400, filed on Sep. 19, 2017.

(51) Int. Cl. B25B 21/00

(52) U.S. Cl. CPC B25B 21/004; B25B 23/0035

(57) ABSTRACT

A powered ratchet comprises a motor, a coupling shaft, a drive member, a ratchet arm, and a ratchet head. The coupling shaft is operably coupled with the motor. The drive member is drivingly coupled with the coupling shaft such that the drive member is rotatable about a first drive axis. The drive member is slidably coupled with the coupling shaft and slidable with respect to the coupling shaft between a retracted position and an extended position. The ratchet arm is slidably and rotatably coupled with each of the coupling shaft and the outer sleeve. The ratchet arm is slidable with respect to the outer sleeve between a retracted position and an extended position. The ratchet head is rotatably coupled with the ratchet arm and operably coupled with the drive member such that rotation of the drive member about the first drive axis facilitates rotation of the ratchet.

### REFERENCE TO RELATED APPLICATION

This application claims priority of U.S. provisional patent application Ser. No. 62/560,400, entitled Ratchet Including a Slidable and Rotatable Ratchet Arm, filed Sep. 19, 2017, and hereby incorporates this provisional patent application by reference herein in its entirety.

### BACKGROUND

Conventional ratchets have a fixed length that cannot be adjusted by a user.

### BRIEF DESCRIPTION OF THE DRAWINGS

It is believed that certain embodiments will be better understood from the following description taken in conjunction with the accompanying drawings in which:

FIG. 1 is an isometric view depicting a telescoping ratchet with a ratchet arm shown in an extended position, in accordance with one embodiment;

FIG. 2 is a cross-sectional view taken along the line 2-2 in FIG. 1, with the ratchet arm and a drive member shown in respective extended positions;

FIG. 3 is a cross-sectional view taken along the line 2-2 in FIG. 1, but with the ratchet arm and the drive member shown in respective retracted positions;

FIG. 4 is an exploded isometric view depicting the telescoping ratchet of FIG. 1;

FIG. 5 is an isometric view depicting a coupling shaft of the telescoping ratchet of FIG. 1;

FIG. 6 is an isometric view depicting a ratchet arm of the telescoping ratchet of FIG. 1; and

FIG. 7 is an isometric view depicting a drive member of the telescoping ratchet of FIG. 1.

### DETAILED DESCRIPTION

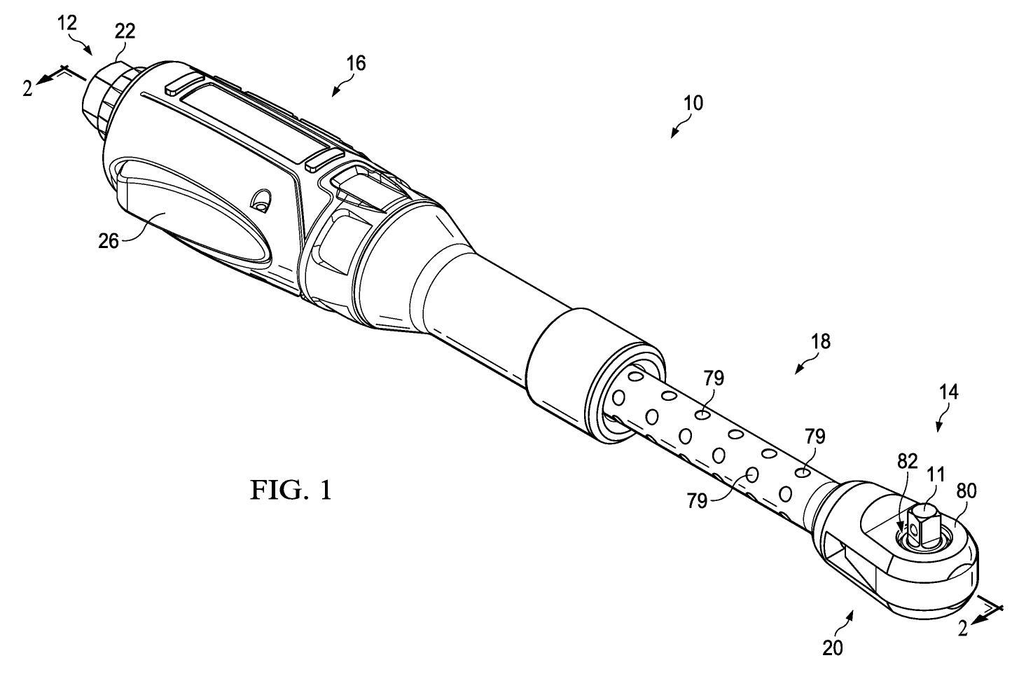

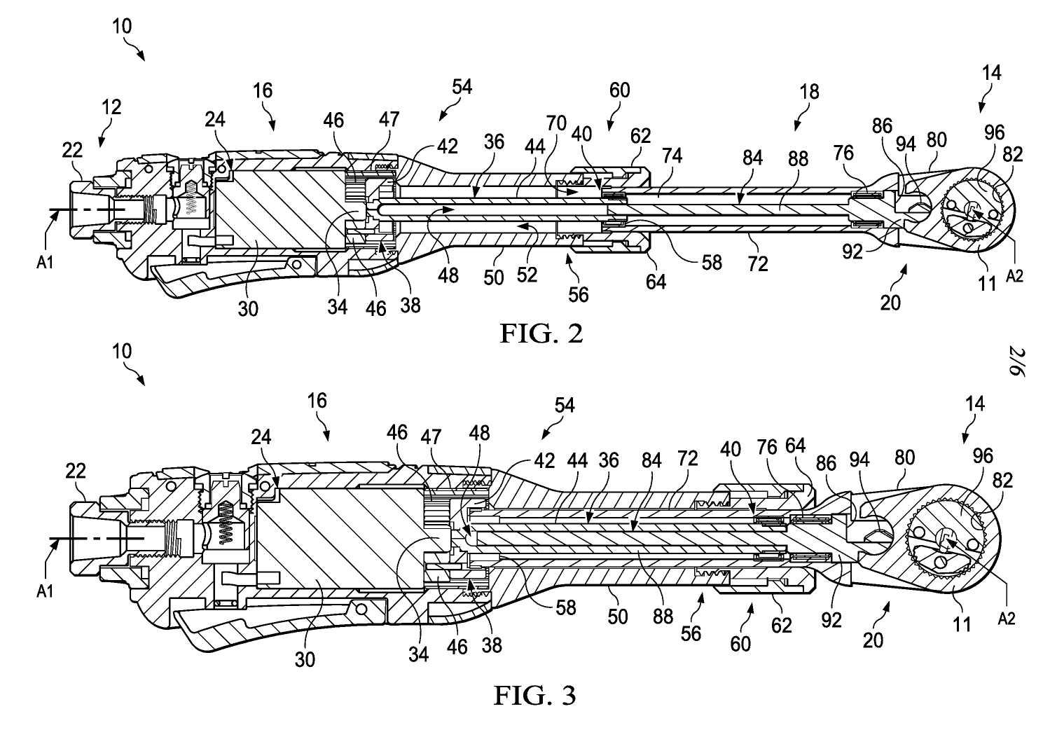

Embodiments are hereinafter described in detail in connection with the views and examples of FIGS. 1-7, wherein like numbers indicate the same or corresponding elements throughout the views. As illustrated in FIGS. 1-4, a powered telescoping ratchet 10 (hereinafter “the ratchet”) facilitates powered driving of a ratchet head 11 to facilitate installation or removal of a threaded fastener such as a bolt or nut, for example. As illustrated in FIG. 1, the ratchet 10 can extend between a proximal end 12 and a distal end 14 and can include a motor housing 16 and a ratchet arm 18. The motor housing 16 can be provided at the proximal end 12 and the ratchet arm 18 can be provided at the distal end 14. The ratchet arm 18 can include a driver support portion 20 (FIG. 2) that rotatably supports the ratchet head 11 for driving a fastener. An air supply port 22 can extend rearwardly from the motor housing 16 and can be configured for fluid coupling with an air compressor (not shown) or another external source of pressurized air or other fluid. The pressurized air provided to the air supply port 22 can facilitate selective powering of the ratchet 10 to rotate a threaded fastener.

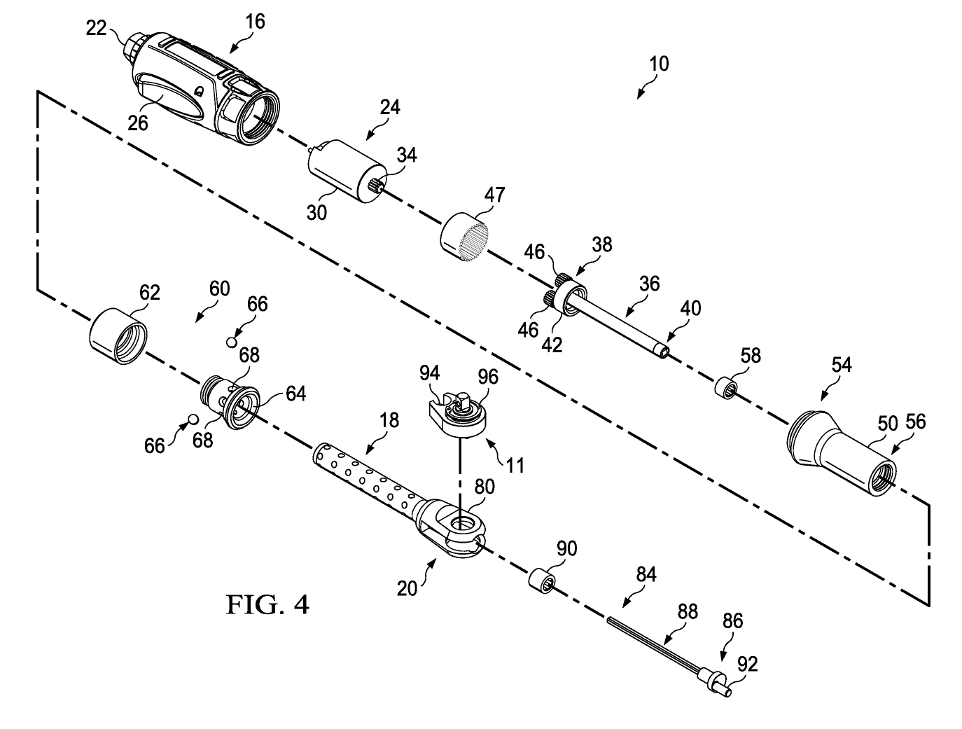

Referring now to FIGS. 2-4, the ratchet 10 can include a rotary motor 24, such as a rotary vane motor, for example, that is at least partially disposed in the motor housing 16. The rotary motor 24 can be in selective fluid communication with the air supply port 22 and can be selectively powered with pressurized air from the air supply port 22. As illustrated in FIG. 4, the ratchet 10 can include a trigger 26 that is pivotally coupled with the motor housing 16. The trigger 26 can be selectively actuated to facilitate operation of the rotary motor 24. The trigger 26 can be associated with a trigger valve assembly(not shown) that is disposed within the motor housing 16. The trigger valve assembly can be selectively actuated by the trigger 26 to facilitate communication of pressurized air from the air supply port 22 to the rotary motor 24. The motor housing 16 can be configured to conform to a user's hand when grasping the motor housing 16 (e.g., to operate the trigger 26).

Referring again to FIGS. 2-4, the rotary motor 24 can include a rotor 30 that is at least partially disposed within the motor housing 16. The rotor 30 can be rotatable with respect to the motor housing 16 about a drive axis A1 (FIGS. 2 and 3). The rotor 30 can be rotatably supported within the motor housing 16 by a bushing (not shown) or other suitable arrangement. The rotary motor 24 can include a driveshaft 34 that is coupled with the rotor 30 and rotatable together with the rotor 30 about the drive axis A1. As will be described in further detail below, the driveshaft 34 can be operably coupled with the ratchet head 11 of the driver support portion 20.

The rotary motor 24 can rotate in each of a clockwise direction and a counterclockwise direction which can correspondingly rotate the ratchet head 11 in either a clockwise direction or a counterclockwise direction to facilitate selective tightening or loosening of an associated fastener. In one embodiment, the ratchet 10 can include a selection switch (not shown) that allows a user to select the rotational direction of the ratchet head 11. It is to be appreciated that any of a variety of suitable alternative pneumatic motors can be used, such as, for example, a linear motor.

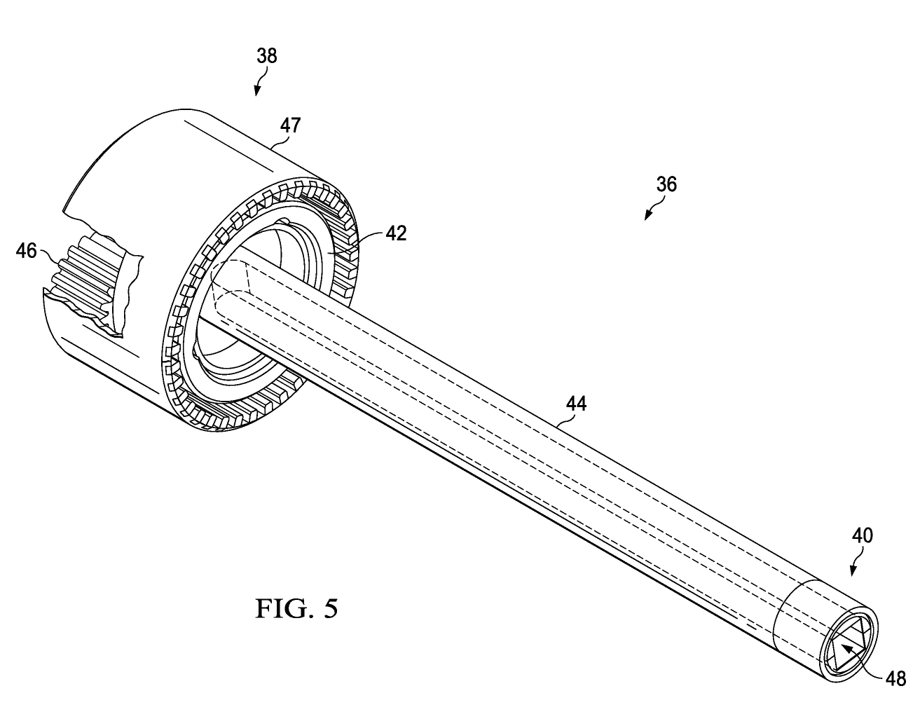

The ratchet 10 can include a coupling shaft 36 that is operably coupled with the rotary motor 24 (e.g., with the driveshaft 34) such that it is rotatable about the drive axis A1. The coupling shaft 36 can have a proximal end 38 and a distal end 40. Referring now to FIGS. 2-4, the proximal end 38 can have a disk shaped portion 42 disposed at the proximal end 38 and a shaped stem 44 that extends therefrom. A plurality of planetary gears 46 can be rotatably coupled with the disk shaped portion 42. A ring gear 47 can surround the planetary gears 46 and can be intermeshed with the planetary gears 46. As illustrated in FIGS. 2 and 3, the driveshaft 34 can extend between the planetary gears 46 and can be intermeshed with the planetary gears 46 such that rotation of the driveshaft 34 in one direction rotates the planetary gears 46 in an opposite direction to rotate the coupling shaft 36 in the same direction as the planetary gears 46. As illustrated in FIGS. 2, 3, and 5, the disk shaped portion 42 and the shaped stem 44 of the coupling shaft 36 can cooperate to define a shaped passageway 48 that extends substantially entirely through the coupling shaft 36 between the proximal end 38 and the distal end 40. In one embodiment, as illustrated in FIG. 5, the shaped passageway 48 can have a substantially square cross-sectional shape (e.g., when taken along a plane that is substantially orthogonal to the drive axis A1).

Referring again to FIGS. 2-4, the ratchet 10 can include an outer sleeve 50 that defines an interior chamber 52 (FIG. 2) and extends between a proximal end 54 (FIG. 4) and a distal end 56 (FIG. 4). As illustrated in FIGS. 2 and 3, the proximal end 54 of the outer sleeve 50 can be threadedly attached to the motor housing 16. The coupling shaft 36 can be disposed in the outer sleeve 50 such that the shaped stem 44 of the coupling shaft 36 extends at least partially through the interior chamber 52.

The ratchet 10 can include a locking assembly 60 that is configured to facilitate selective locking of the position of the ratchet arm 18 relative to the outer sleeve 50. The locking assembly 60 can include a lock sleeve 62, a coupler housing 64 and a plurality of balls 66 (two shown in FIG. 4) that are disposed between the lock sleeve 62 and the coupler housing 64. The coupler housing 64 can define a plurality of apertures 68 (FIG. 4) for the balls 66.

As illustrated in FIGS. 2 and 3, the coupler housing 64 can be threadedly coupled with the distal end 56 of the outer sleeve 50 and can define a passageway 70 (FIG. 2). The lock sleeve 62 can surround the coupler housing 64 with the balls 66 disposed therebetween. The lock sleeve 62 can be slidable with respect to the coupler housing 64 and can be biased towards the distal end 14 of the ratchet 10 (e.g., into a released position) by a spring (not shown). When the lock sleeve 62 is in the released position, as shown in FIGS. 2 and 3, the lock sleeve 62 can interact with the balls 66 to urge the balls 66 into engagement with each of the apertures 68 such that a portion of each of the balls 66 extends through one of the apertures 68 and into the passageway 70 to facilitate retention of the position of the ratchet arm 18 with respect to the outer sleeve 50, as will be described in further detail below.

When the lock sleeve 62 is slid into a retracted position (e.g., towards the proximal end 12 of the ratchet 10), the balls 66 can be released away from the apertures 68 and out of the passageway 70 to release the ratchet arm 18 from the locking assembly 60, as will be described in further detail below.

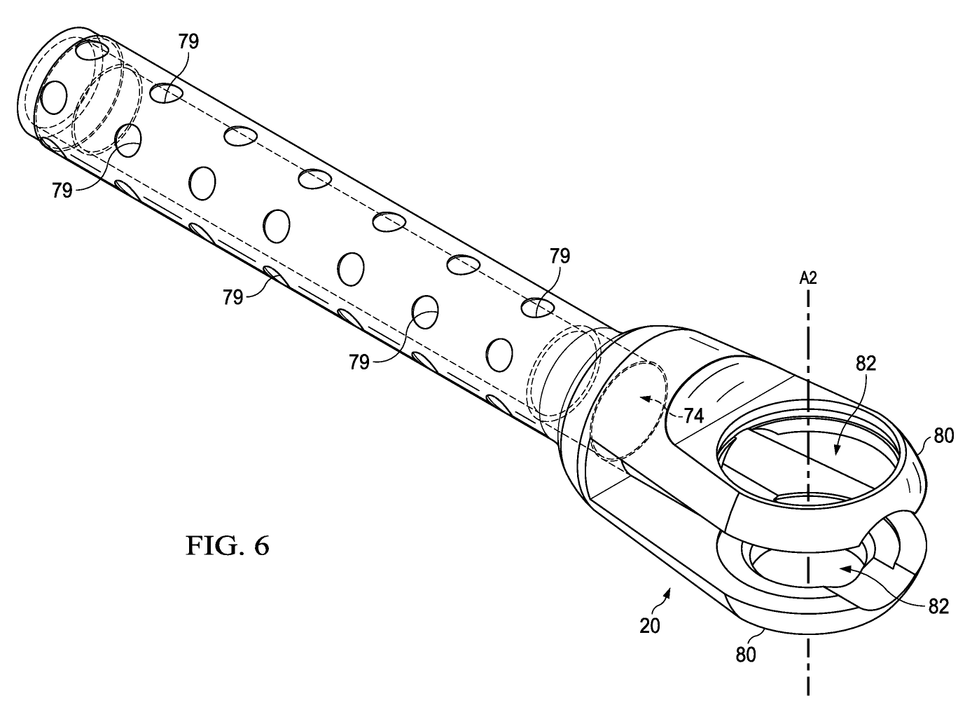

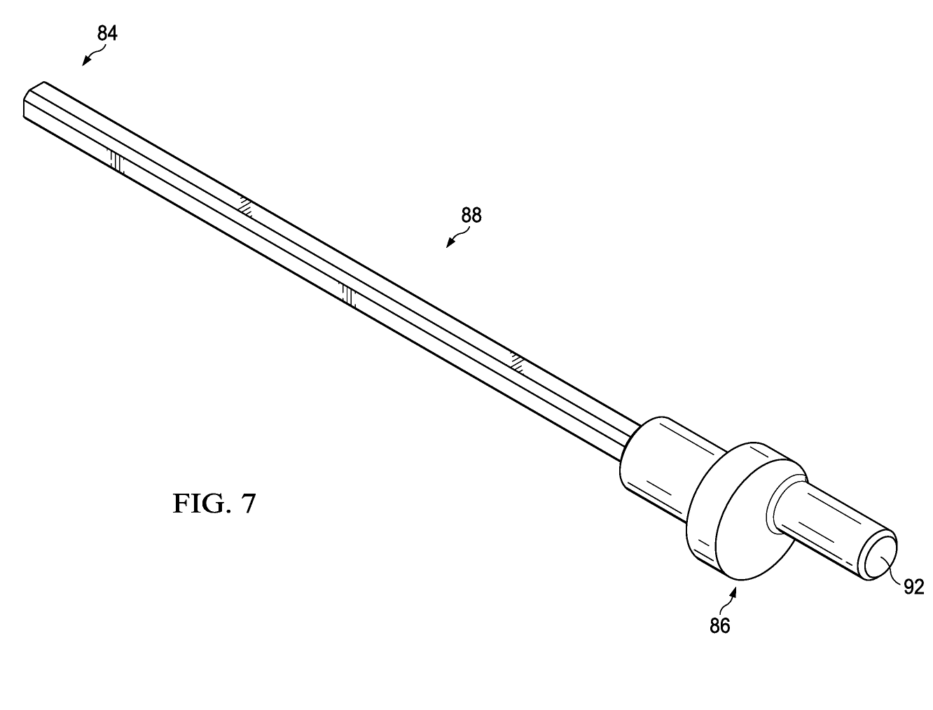

Referring now to FIGS. 2-4 and 6, the ratchet arm 18 can have a body 72 that extends from the driver support portion 20 and defines a passageway 74 (FIG. 6) that extends entirely through the body 72 to the driver support portion 20. The body 72 can be surrounded by the coupler housing 64 and can surround the at least a portion of the shaped stem 44 of the coupling shaft 36 such that the body 72 is interposed between the coupler housing 64 and the shaped stem 44. As illustrated in FIGS. 2 and 3, the ratchet arm 18 can be slidably coupled with the outer sleeve 50 and slidable with respect to the outer sleeve 50 between an extended position (FIG. 2) and a retracted position (FIG. 3). When the ratchet arm 18 is in the extended position, the body 72 of the ratchet arm 18 can be substantially entirely withdrawn from the interior chamber 52 of the outer sleeve 50 with a portion of the body 72 disposed at the distal end 40 of the coupling shaft 36 and the coupler housing 64 and the remaining portion of the body 72 extending beyond the distal end 40 of the coupling shaft 36 and the coupler housing 64. When the ratchet arm 18 is in the retracted position, the body 72 can be substantially entirely disposed in the interior chamber 52 of the outer sleeve 50 such that the body 72 extends between the proximal and distal ends 38, 40 of the coupling shaft 36.

The body 72 can be slidably and rotatably coupled with each of the coupling shaft 36 and the outer sleeve 50 (via the coupler housing 64). A bearing 58 can be interposed between the distal end 40 of the coupling shaft 36 and the body 72 to facilitate such slidable and rotatable coupling. The ratchet arm 18 can accordingly be slid along the shaped stem 44 (e.g., along the drive axis A1) between the extended position (FIG. 2) and the retracted position (FIG. 3) to facilitate selection of the overall length of the ratchet 10. The ratchet arm 18 can also be rotated with respect to the shaped stem 44 (e.g., about the drive axis A1) to facilitate manual selection of the rotational orientation of the driver support portion 20 relative to the motor housing 16.

As illustrated in FIG. 6, the body 72 can define a plurality of recesses 79 that can interact with the balls 66 to hold the ratchet arm 18 in position when the lock sleeve 62 is in the extended position. The recesses 79 can be distributed along the length and circumference of the body 72 such that each recess 79 correlates to a different length and rotational orientation of the ratchet arm 18, as will be described in further detail below.

The driver support portion 20 can include a pair of arm members 80 that extend away from the body 72 and are spaced from each other. Each of the arm members 80 can define an aperture 82. The ratchet head 11 can be rotatably supported by the arm members 80 and can reside at least partially in the apertures 82 to facilitate rotation of the drive member along a drive axis A2 (FIG. 6) that is substantially perpendicular to the drive axis A1 (FIG. 2).

Referring now to FIGS. 2-4 and 7, the ratchet 10 can include a drive member 84 that is drivingly coupled with the coupling shaft 36. As illustrated in FIG. 7, the drive member 84 can include an engagement end 86 and a body 88 that extends from the engagement end 86. The body 88 can have a substantially square cross-sectional shape that corresponds with the square cross-sectional shape of the shaped passageway 48. As illustrated in FIG. 2, the body 88 of the drive member 84 can be disposed within the shaped passageway 48 of the coupling shaft 36 such that the drive member 84 is drivingly coupled with the coupling shaft 36 (e.g., the coupling shaft 36 and the drive member 84 are rotatable together about the drive axis A1 when the coupling shaft 36 is actuated by the rotary motor 24).

The drive member 84 can also be slidably coupled with the coupling shaft 36 and slidable with respect to the coupling shaft between an extended position (FIG. 2) and a retracted position (FIG. 3). When the drive member 84 is in the extended position, the body 88 can be spaced from the proximal end 38 of the coupling shaft 36 and supported by the distal end 40 of the coupling shaft 36 such that a portion of the body 88 extends beyond the coupling shaft 36. When in the retracted position, the body 88 can be substantially entirely disposed in the shaped passageway 48 of the shaped stem 44 such that the body 88 is supported by each of the proximal and distal ends 38, 40 of the coupling shaft 36. The corresponding cross-sectional shapes of the shaped passageway 48 and the body 88 of the drive member 84 can allow the drive member 84 to slide relative to the coupling shaft while maintaining driveable coupling therebetween. It is to be appreciated that the shaped stem 44 and the shaped passageway 48 can have any of a variety of suitable alternative corresponding cross-sectional shapes that facilitate slidable and driveable coupling, such as a splined arrangement, for example. It is also to be appreciated that the drive member 84 can alternatively define a passageway (not shown) that receives the coupling shaft 36 to facilitate slidable and driveable coupling therebetween.

Still referring to FIGS. 2 and 3, the drive member 84 can be disposed in the passageway 74 of the body 72 of the ratchet arm 18 and rotatably coupled with the body 72. A bearing 76 can journal the drive member 84 with respect to the body 72 of the ratchet arm 18. The engagement end 86 of the drive member 84 can be disposed at the driver support portion 20 to facilitate engagement with the ratchet head 11. The engagement end 86 can include a pin 92 that is offset from (e.g., spaced from) the drive axis A1 (see FIG. 6) such that the pin 92 rotates about the drive axis A1. The pin 92 can engage the ratchet head 11 in such a manner that facilitates rotation of the ratchet head 11 with respect to the driver support portion 20. In one embodiment, as illustrated in FIG. 4, the ratchet head 11 can include a drive bushing 94 and a hammer 96, and the pin 92 can engage the drive bushing 94 to facilitate rotation of the hammer 96 about the drive axis A2.

The drive member 84 can accordingly be axially coupled with the ratchet arm 18 (i.e., not slidable relative to the ratchet arm 18) such that the drive member 84 is slidable together with the ratchet arm 18 between their respective extended positions and the retracted positions. As such, when the ratchet arm 18 is slid by a user to change the overall length of the ratchet 10, the drive member 84 remains drivingly coupled with each of the coupling shaft 36 and the ratchet head 11 to facilitate driving of the ratchet head 11 with the rotary motor 24 irrespective of the position of the ratchet arm 18 relative to the outer sleeve 50.

The method for selecting a length and a rotational orientation of the ratchet arm 18 will now be discussed. When a user desires to change the length of the ratchet 10 and/or the rotational orientation of the driver support portion 20 relative to the motor housing 16, the user can manually slide the lock sleeve 62 into the retracted position which can release the balls 66 from the apertures 68 of the coupler housing 64 thereby disengaging the ratchet arm 18 from the locking assembly 60. The ratchet arm 18 can then be slid to a desired length and/or rotated to a desired rotational orientation. The lock sleeve 62 can then be released which can allow the lock sleeve 62 to automatically slide to the released position (e.g., via the spring). If the recesses 79 on the body 72 are aligned with the apertures 68 of the coupler housing 64, the lock sleeve 62 can urge the balls 66 into engagement with the apertures 68 to hold the ratchet arm 18 in position. If the recesses 79 on the body 72 are misaligned with the apertures 68 of the coupler housing 64, the user can manually adjust the position of the ratchet arm 18 until the recesses 79 on the body 72 become aligned with the apertures 68 of the coupler housing 64 to allow the lock sleeve 62 to urge the balls 66 into engagement with the apertures 68 to hold the ratchet arm 18 in position. As such, the ratchet arm 18 can be selectively positioned to achieve a desired length of rotational orientation such that the ratchet 10 can be more versatile than conventional fixed ratchets.

It is to be appreciated that, although a pneumatic ratchet is described above, the telescoping and/or rotational features can be implemented in any of a variety of suitable alternative powered ratchets (e.g., electrically powered).

The foregoing description of embodiments and examples of the disclosure has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate the principles of the disclosure and various embodiments as are suited to the particular use contemplated. In some embodiments, the drawings can be understood to be drawn to scale. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A pneumatically powered ratchet comprising:
a motor housing;
a pneumatic motor at least partially disposed in the motor housing;
an air supply port extending from the motor housing and configured for fluid coupling with a fluid source;
a trigger movably coupled with the motor housing and movable to facilitate selective communication of pressurized air from the air supply port to the pneumatic motor;
an outer sleeve coupled with the motor housing and defining an interior chamber;
a coupling shaft operably coupled with the pneumatic motor, the coupling shaft being at least partially disposed in the outer sleeve and rotatable about a first drive axis;
a drive member drivingly coupled with the coupling shaft such that the drive member is rotatable together with the coupling shaft about the first drive axis, and the drive member being slidably coupled with the coupling shaft and slidable with respect to the coupling shaft between a retracted position and an extended position;
a ratchet arm defining a passageway, the ratchet arm being slidably and rotatably coupled with each of the coupling shaft and the outer sleeve, the ratchet arm being slidable with respect to the outer sleeve between a retracted position and an extended position; and
a ratchet head rotatably coupled with the ratchet arm and operably coupled with the drive member such that rotation of the drive member about the first drive axis facilitates rotation of the ratchet head about a second drive axis that is different from the first drive axis, wherein:
the ratchet arm defines a passageway;
the drive member is disposed in the passageway of the ratchet arm and rotatably coupled with the ratchet arm such that the drive member is rotatable about the first drive axis with respect to the ratchet arm; and
the drive member is axially coupled with the ratchet head such that the drive member and the ratchet head slide together between their respective retracted positions and extended positions.

2. The pneumatically powered ratchet of claim 1 further comprising a locking assembly that is configured to facilitate selective locking of the position of the ratchet arm relative to the outer sleeve.

3. The pneumatically powered ratchet of claim 2 wherein the locking assembly comprises a lock sleeve, a coupler housing, and a plurality of balls disposed between the lock sleeve and the coupler housing, wherein the lock sleeve is slidable relative to the coupler housing to facilitate selective locking of the position of the ratchet arm relative to the outer sleeve.

4. The pneumatically powered ratchet of claim 3 wherein the ratchet arm comprises a body that defines a plurality of recesses that selectively interact with the plurality of balls to facilitate selective locking of the position of the ratchet arm relative to the outer sleeve.

5. The pneumatically powered ratchet of claim 1 wherein the pneumatic motor comprises a rotary motor that comprises a rotor and a drive shaft coupled with the rotor.

6. The pneumatically powered ratchet of claim 5 wherein the coupling shaft comprises at least one gear rotatably coupled with the coupling shaft and intermeshed with the drive shaft.

7. The pneumatically powered ratchet of claim 6 wherein the at least one gear comprises a plurality of planetary gears and wherein the pneumatically powered ratchet further comprises a ring gear that surrounds the plurality of planetary gears and is intermeshed with the plurality of planetary gears.

8. The pneumatically powered ratchet of claim 1 wherein the coupling shaft defines a shaped passageway having a cross-sectional shape, and the drive member comprises a shaped stem having a cross-sectional shape that corresponds with the cross-sectional shape of the coupling shaft.

9. The pneumatically powered ratchet of claim 8 wherein the coupling shaft and the shaped stem each have a substantially square cross-sectional shape.

10. A powered ratchet comprising:
a motor housing;
a rotary motor at least partially disposed in the motor housing;
a trigger movably coupled with the motor housing and movable to facilitate selective operation of the rotary motor;
an outer sleeve coupled with the motor housing and defining an interior chamber;
a coupling shaft operably coupled with the rotary motor, the coupling shaft being at least partially disposed in the outer sleeve and rotatable about a first drive axis;
a drive member drivingly coupled with the coupling shaft such that the drive member is rotatable together with the coupling shaft about the first drive axis, and the drive member being slidably coupled with the coupling shaft and slidable with respect to the coupling shaft between a retracted position and an extended position;
a ratchet arm defining a passageway, the ratchet arm being slidably and rotatably coupled with each of the coupling shaft and the outer sleeve, the ratchet arm being slidable with respect to the outer sleeve between a retracted position and an extended position; and
a ratchet head rotatably coupled with the ratchet arm and operably coupled with the drive member such that rotation of the drive member about the first drive axis facilitates rotation of the ratchet head about a second drive axis that is different from the first drive axis, wherein:
the ratchet arm defines a passageway;
the drive member is disposed in the passageway of the ratchet arm and rotatably coupled with the ratchet arm such that the drive member is rotatable about the first drive axis with respect to the ratchet arm; and
the drive member is axially coupled with the ratchet head such that the drive member and the ratchet head slide together between their respective retracted positions and extended positions.

11. The powered ratchet of claim 10 further comprising a locking assembly that is configured to facilitate selective locking of the position of the ratchet arm relative to the outer sleeve.

12. The powered ratchet of claim 11 wherein the locking assembly comprises a lock sleeve, a coupler housing, and a plurality of balls disposed between the lock sleeve and the coupler housing, wherein the lock sleeve is slidable relative to the coupler housing to facilitate selective locking of the position of the ratchet arm relative to the outer sleeve.

13. The powered ratchet of claim 12 wherein the ratchet arm comprises a body that defines a plurality of recesses that selectively interact with the plurality of balls to facilitate selective locking of the position of the ratchet arm relative to the outer sleeve.

14. The powered ratchet of claim 10 wherein:
the rotary motor comprises a rotor and a drive shaft coupled with the rotor;
the coupling shaft comprises a plurality of planetary gears coupled with the coupling shaft and intermeshed with the drive shaft; and
the powered ratchet further comprises a ring gear that surrounds the plurality of planetary gears and is intermeshed with the plurality of planetary gears.

15. The powered ratchet of claim 10 wherein the coupling shaft defines a shaped passageway having a cross-sectional shape, and the drive member comprises a shaped stem having a cross-sectional shape that corresponds with the cross-sectional shape of the coupling shaft.

16. The powered ratchet of claim 15 wherein the coupling shaft and the shaped stem each have a substantially square cross-sectional shape.

17. A powered ratchet comprising:
a motor housing;
a motor at least partially disposed in the motor housing;
a trigger movably coupled with the motor housing and movable to facilitate selective operation of the motor;
an outer sleeve coupled with the motor housing and defining an interior chamber;
a coupling shaft operably coupled with the motor and defining a shaped passageway having a cross-sectional shape, the coupling shaft being at least partially disposed in the outer sleeve and rotatable about a first drive axis;
a drive member comprising a shaped stem having a cross-sectional shape, the shaped stem being at least partially disposed in the shaped passageway such that the drive member is drivingly coupled with the coupling shaft and rotatable together with the coupling shaft about the first drive axis and such that the drive member is slidably coupled with the coupling shaft and is slidable with respect to the coupling shaft between a retracted position and an extended position;
a ratchet arm defining a passageway, the ratchet arm being slidably and rotatably coupled with each of the coupling shaft and the outer sleeve, the ratchet arm being slidable with respect to the outer sleeve between a retracted position and an extended position; and
a ratchet head rotatably coupled with the ratchet arm and operably coupled with the drive member such that rotation of the drive member about the first drive axis facilitates rotation of the ratchet head about a second drive axis that is different from the first drive axis, wherein:
the ratchet arm defines a passageway;
the drive member is disposed in the passageway of the ratchet arm and rotatably coupled with the ratchet arm such that the drive member is rotatable about the first drive axis with respect to the ratchet arm; and
the drive member is axially coupled with the ratchet head such that the drive member and the ratchet head slide together between their respective retracted positions and extended positions.

18. The powered ratchet of claim 17 wherein the coupling shaft and the shaped stem each have a substantially square cross-sectional shape.

19. The powered ratchet of claim 17 further comprising a locking assembly that is configured to facilitate selective locking of the position of the ratchet arm relative to the outer sleeve.

20. The powered ratchet of claim 19 wherein:
the locking assembly comprises a lock sleeve, a coupler housing, and a plurality of balls disposed between the lock sleeve and the coupler housing;
the lock sleeve is slidable relative to the coupler housing to facilitate selective locking of the position of the ratchet arm relative to the outer sleeve; and
the ratchet arm comprises a body that defines a plurality of recesses that selectively interact with the plurality of balls to facilitate selective locking of the position of the ratchet arm relative to the outer sleeve.
